(19) United States
(12) Patent Application Publication
(10) Pub. No.: US 2011/0051730 A1
(43) Pub. Date: Mar. 3, 2011

(54) MULTI-LAYER DATA PROCESSING APPARATUS AND METHOD THEREOF

(75) Inventors: Dong-Myoung BAEK, Daejeon-si (KR); Bhum-Cheol Lee, Daejeon-si (KR); Jung-Hee Lee, Daejeon-si (KR); Sang-Yoon Oh, Daejeon-si (KR); Seung-Woo Lee, Daejeon-si (KR)

(73) Assignee: ELECTRONICS AND TELECOMMUNICATIONS RESEARCH INSTITUTE, Daejeon-si (KR)

(21) Appl. No.: 12/845,335

(22) Filed: Jul. 28, 2010

(30) Foreign Application Priority Data
Sep. 1, 2009 (KR) 10-2009-0081947
Dec. 21, 2009 (KR) 10-2009-0128025

(51) Int. Cl. H04L 12/56

(52) U.S. Cl. 370/392

(57) ABSTRACT

A multi-layer data processing apparatus and method. The multi-layer data processing unit may classify received multi-layer data into lower layer data and higher layer data using lower layer information, and generate and output a traffic flow of the lower layer data or traffic flows of the lower layer data and the higher layer data with reference to a rule information table. In the rule information table, pieces of lower layer rule information may be linked to pieces of higher layer rule information.

### CROSS REFERENCE TO RELATED APPLICATION

This application claims the benefit under 35 U.S.C. §119(a) of Korean Patent Application Nos. 10-2009-0081947, filed on Sep. 1, 2009, and 10-2009-0128025, filed on Dec. 21, 2009, all disclosures of which are incorporated herein by references for all purposes.

### BACKGROUND

1. Field

The following description relates to multi-layer data processing, and more particularly, to a multi-layer data processing apparatus and method for efficiently processing multi-layer data using properties of layers.

2. Description of the Related Art

The Open System Interconnection (OSI) Seven Layer Model is widely used as a layered protocol design because it is conceptually and structurally easy to implement.

The Layer 1 of the OSI Seven Layer Model is a Physical Layer and the bottom layer that controls a physical access between devices, and the Layers 2 to 4 are determined according to a transfer scheme. The Layer 2 that is the Data Link Layer is involved with Ethernet technology. The Layer 3 that is the Network Layer and the Layer 4 that is the Transport Layer are layers to which Internet protocols belong. The Layer 5 that is the Session Layer provides an interface between a user and the Transport Layer and supports a user access device. The Layer 6 which is the Presentation Layer allows application programs to translate different formats, settings and encryption of information therebetween, and thereby the application programs can connect with each other. The Layer 7 that is the Application Layer is the top layer through which application processors connected through a communication network exchange information therebetween.

The Layers 2 to 4 process data such as frames or packets using dedicated hardware or network processor, and improvement of performance efficiency of such layers has become a major issue. Furthermore, achieving flexibility in processing various types of data is a main issue for the Layer 7 that processes data in a software manner using a general purpose processor.

That is, with the advent of a multi-core processor and the recent trend of integration and fusion of various transfer schemes, a need for developing the data processing capabilities of the Layers 2 to 4 (hereinafter they will be referred to as lower layers) and the Layer 7 (hereinafter, it will be referred to as a higher layer) is increasing. In particular, for packet inspection and heterogeneous network interworking, improvement of data processing capabilities of the Layers 2 to 7 is inevitably required.

However, according to the conventional data processing methods, a contradiction occurs between lower layers which more focus on data processing capabilities and a higher layer which emphasizes flexibility in data processing, so that one of the data processing capability of the lower layers and the flexibility of processing various types of data of the higher layer should be selected. That is, the conventional methods cannot satisfy both the data processing capability of the lower layer and the flexibility in data processing of the higher layer at the same time.

To overcome such drawbacks, one of conventional methods suggests that a lower layer itself processes data and transfers the processed data to a higher layer and the higher layer uses the transferred data to improve the data processing capabilities of the higher and lower layers. The above conventional method enables increasing of the data processing performance of the higher layer, and allows the lower layer to process the data independently from the higher layer.

However, the conventional method still has disadvantages of low efficiency of data integrated processing at the higher layer and the lower layer during packet inspection or heterogeneous network interworking, due to the difference in the data processing capabilities between the higher layer and the lower layer.

In another conventional method, packet inspection is performed in stages, and functions specified for the respective stages are performed to process lower layer data and higher layer data in an integrated manner with a simple structure. This conventional method can integrate and process the lower layer data and the higher layer data with a simple structure, and particularly, can classify and process packets which are needed to be processed at the higher layer.

However, according to the conventional method, the functions specified for the respective stages are not divided according to the layers, and thus high flexibility in processing data in each stage cannot be achieved. Furthermore, there is no interworking between the higher layer and the lower layer, and thus the lower layer cannot utilize data of the higher layer.

### SUMMARY

In one general aspect, there is provided a multi-layer data processing apparatus including: a lower layer processing unit to classify received multi-layer data into lower layer data and higher layer data using lower layer information, generate a traffic flow of the lower layer data or traffic flows of the lower layer data and the higher layer data with reference to a rule information table in which pieces of lower layer rule information are linked to pieces of higher layer rule information and output the generated traffic flow(s).

The lower layer processing unit may include a lower layer classifying unit to classify the received multi-layer data into the lower layer data and the higher layer data using the pieces of lower layer information, and a local table processing unit to generate a traffic flow of each layer with reference to the rule information table in which the pieces of lower layer rule information related to processing of the lower layer data are linked to the pieces of higher layer rule information of the higher layer data that has been previously processed at a higher layer.

The local table processing unit may include a local table unit to include the rule information table in which the pieces of lower layer rule information related to processing of the lower layer data are linked to the pieces of higher layer rule information of the higher layer data which has been previously processed by the higher layer processing unit in a ‘one-to-one’ or ‘one-to-n’ relationship where n is a natural number greater than or equal to 2.

The local table processing unit may include a rule information acquiring unit to acquire the lower layer rule information related to processing of the lower layer data from the rule information table of the local table unit when the lower layer classifying unit has classified the multi-layer data into the lower layer data and the higher layer data, and a multi-layer traffic flow generating unit to generate the traffic flow of the lower layer data.

The rule information acquiring unit may check whether higher layer rule information that corresponds to the acquired lower layer rule information is present in the rule information table of the local table unit, and request the multi-layer traffic flow generating unit to generate the traffic flow of the higher layer data if the corresponding higher layer rule information is present, or otherwise, request the lower layer classifying unit to transmit the higher layer data to the higher layer processing unit.

The multi-layer data processing apparatus may further include: a global table unit to store a global rule information table storing global rule information of all layers; and a higher layer processing unit to receive the higher layer data from the lower layer processing unit, generate a traffic flow of the higher layer data using rule information of the global rule information table of the global table unit and output the generated traffic flow when the traffic flow of the higher layer data was not able to be generated by the lower layer processing unit.

The higher layer processing unit may include a higher layer classifying unit to analyze the higher layer data received from the lower layer classifying unit, obtain rule information related to the received higher layer data from the global information table of the global table unit according to the analysis result, and transmit the obtained rule information to the lower layer processing unit, and a higher layer traffic flow generating unit to generate the traffic flow of the higher layer data using the rule information obtained by the higher layer classifying unit.

The local table processing unit may include a rule information updating unit to update the rule information table of the local table unit using at least one of the rule information obtained from the higher layer classifying unit, state information of the traffic flow generated by the multi-layer traffic flow generating unit, and the lower layer information.

Other features and aspects will be apparent from the following detailed description, the drawings, and the claims.

### BRIEF DESCRIPTION OF THE DRAWINGS

FIG. 1 is a diagram illustrating an example of a multi-layer data processing apparatus.

FIG. 2 is a diagram illustrating an example showing in detail the multi-layer data processing apparatus shown in FIG. 1.

FIG. 3 is a diagram illustrating an example of how to process multi-layer data using a data processing apparatus in a heterogeneous network interworking scheme.

FIG. 4 is a flowchart of an example of a method of processing multi-layer data.

FIG. 5 is a flowchart of an example of a method of generating a traffic flow of multi-layer data.

FIG. 6 is a flowchart of an example of a method of updating a rule information table of a local table.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

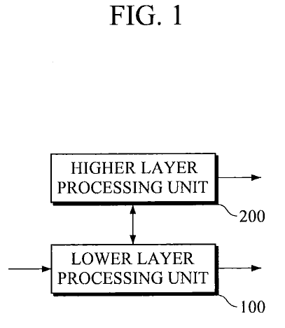

FIG. 1 illustrates an example of a multi-layer data processing apparatus. Referring to FIG. 1, a multi-layer data processing apparatus include a lower layer processing unit 100 for Layers 2 to 4 and a higher layer processing unit 200 for a Layer 7 of the open system interconnection seven layer model. The lower layer processing unit 100 integrates multi-layer data and processes the data. Here, the multi-layer data refers to lower layer data and higher layer data. The lower layer processing unit 100 generates a traffic flow of input multi-layer data and outputs the generated traffic flow. The higher layer processing unit 200 generates a traffic flow of higher layer data received from the lower layer processing unit 100, and outputs the generated traffic flow. That is, the higher layer processing unit 200 uses the received higher layer data and information related to the higher layer data to generate the traffic flow, and transfers relevant information to the lower layer processing unit 100. In response to input of the multi-layer data the lower layer processing unit 100 which has stored the information transferred from the higher layer processing unit 200 uses the stored information to generate and output the traffic flow of the input multi-layer data. Accordingly, the multi-layer data processing apparatus shown in the example illustrated in FIG. 1 can integrate and process the multi-layer data using the lower layer processing unit 100.

Since the processing speeds become different between the layers when the multi-layer data is integrated and processed using the information obtained by processing the higher layer data in the higher layer processing unit 200 as described above, the lower layer processing unit 100 needs to match a processing speed to the higher layer processing unit 200 and process the lower layer data at the adjusted processing speed. However, generally, at most times, the lower layer processing unit 100 does not need to use the information related to the higher layer data processed by the higher layer processing unit 200 in real time. In addition, since performance of a higher layer processor that implements an application layer has been gradually improved, the output capability of the higher layer processing unit 200 that is required by the lower layer processing unit 100 has been developed to be close to the data processing speed of the lower layer processing unit 100. Thus, the above mentioned drawback can be solved.

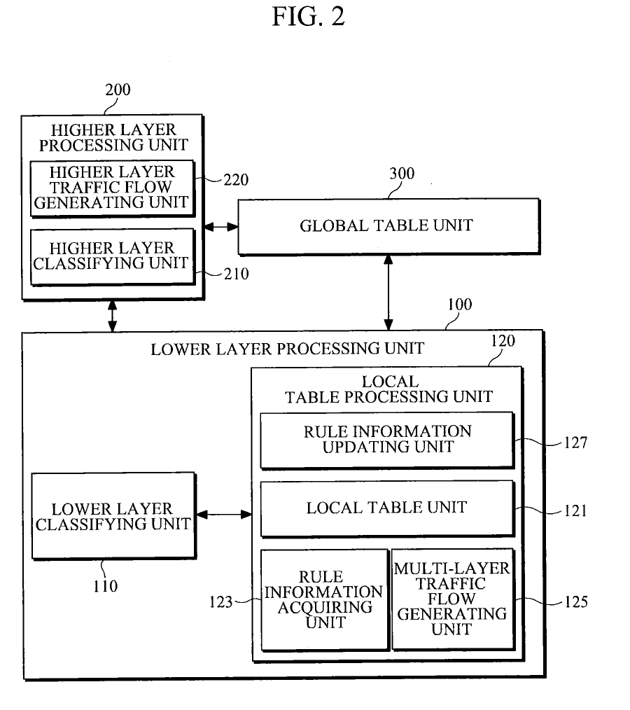

Hereinafter, the description of the multi-layer data processing apparatus will be provided in detail with reference to FIG. 2.

FIG. 2 illustrates an example showing in detail the multi-layer data processing apparatus shown in FIG. 1. Referring to FIG. 2, the multi-layer data processing apparatus includes the lower layer processing unit 100 and the higher layer processing unit 200.

In response to receiving multi-layer data, the lower layer processing unit 100 uses lower layer information to classify the received multi-layer data into lower layer data and higher layer data. Then, the lower layer processing unit 100 uses a rule information table to generate and output a traffic flow of the lower layer data or a traffic flow of the higher layer data, wherein in the rule information table, rule information of a lower layer is matched with rule information of a higher layer. To this end, the lower layer processing unit 100 may include a lower layer classifying unit 110 and a local table processing unit 120. The lower layer classifying unit 110 uses lower layer information of the received multi-layer data to classify the multi-layer data into the lower layer data and the higher layer data.

The local table processing unit 120 generates traffic flows for the respective layers with reference to the rule information table in which lower layer rule information related to processing of the lower layer data is matched with higher layer rule information of the higher layer data previously processed by the higher layer processing unit 200. Then, the local table processing unit 120 outputs the generated traffic flows. The local table processing unit 120 may include a local table unit 121, a rule information acquiring unit 123, and a multi-layer traffic flow generating unit 125.

The local table unit 121 may form the rule information table in which the lower layer rule information related to processing of the lower layer data is matched with the higher layer rule information of the higher layer data previously processed by the higher layer processing unit 200.

Here, the lower layer rule information may be a rule set and action table based on Layer 2-4, and the higher layer rule information may be a rule set and action table based on Layer 7. As such, the local table unit 121 may form the rule information table such that rows of the rule set and action table based on the Layer 2-4 are linked to rows of the rule set and action table based on the Layer 7 in a ‘one-to-one’ or ‘one-to-n (n is a natural number greater than or equal to 2)’ relationship.

Once the lower layer classifying unit classifies the received multi-layer data into the lower layer data and the higher layer data, the rule information acquiring unit 123 acquires the lower layer rule information related to processing of the lower layer data through the local table unit 121. In this case, the lower layer data may have a key value, and the rule information table of the local table unit 121 may include identification information of the key value. Hence, the rule information acquiring unit 123 acquires the lower layer rule information from the rule information table including the key value of the lower layer data and the identification information of the key value of the local table unit 121. When acquiring the lower layer rule information, the rule information acquiring unit 123 checks whether there is higher layer rule information corresponding to the acquired lower layer rule information. If there is corresponding higher layer rule information, the rule information acquiring unit 123 acquires the corresponding higher layer rule information. As described above, the local table unit 121 forms the rule information table such that the rows of the rule set and action table based on Layer 2-4 are linked to rows of the rule set and action table based on the Layer 7 in a ‘one-to-one’ or ‘one-to-n (n is a natural number greater than or equal to 2)’ relationship. Accordingly, the rule information acquiring unit 123 may acquire the higher layer rule information corresponding to the lower layer rule information from the local table unit 121.

The multi-layer traffic flow generating unit 125 uses the lower layer rule information obtained by the rule information acquiring unit 123 to generate a traffic flow of the lower layer data. In this case, if the higher layer rule information that corresponds to the lower layer rule information is obtained by the rule information acquiring unit 123, the multi-layer traffic flow generating unit 125 uses the higher layer rule information to generate a traffic flow of the higher layer data. As described above, the multi-layer data processing apparatus shown in the example illustrated in FIG. 2 integrates and processes the multi-layer data using the lower layer processing unit 100.

If it is determined that there is no higher layer rule information that corresponds to the lower layer rule information, the rule information acquiring unit 123 requests the lower layer classifying unit 110 to transfer the higher layer data to the higher layer processing unit 200. In response to the request, the lower layer classifying unit 110 transfers to the higher layer processing unit 200 the higher layer data of which the traffic flow has not been generated. Then, the higher layer processing unit 200 generates the traffic flow of the requested higher layer data and outputs the generated traffic flow. That is, when receiving the higher layer data generated by the lower layer classifying unit 110, of which the traffic flow has not been generated, the higher layer processing unit 200 uses a global table unit 300 including a rule information table of all layers to generate the traffic flow of the higher layer data and outputs the generated traffic flow. The global table unit 300 may be formed of a rule information table that is a rule set and action table based on all Layers. The rule information table may include key values of data at the respective layers and pieces of identification information related to the key values. As such the higher layer processing unit 200 is enable to generate and output the traffic flow of the higher layer data by the higher layer classifying unit 210 and the higher layer traffic flow generating unit 220.

When receiving the higher layer data from the lower layer classifying unit 110, the higher layer classifying unit 210 acquires rule information involved with the received higher layer data from the rule information table of the global table unit 300. Thereafter, the higher layer classifying unit 210 transmits the obtained rule information to the lower layer processing unit 100. However, the order of transmission of the obtained rule information may be varied, and thus the higher layer classifying unit 210 may transmit the obtained rule information to the lower layer processing unit 100 after the traffic flow of the higher layer data is generated and output. Once the rule information related to the higher layer data is obtained by the higher layer classifying unit 210, the higher layer traffic flow generating unit 220 uses the obtained rule information to generate the traffic flow of the higher layer data. Specifically, when receiving the higher layer data from the lower layer classifying unit 110 of the lower layer processing unit 100, the higher layer classifying unit 210 obtains a key value of the received higher layer data. Then, the higher layer classifying unit 210 obtains the higher layer rule information of the rule information table of the global table unit 300, wherein the rule information table includes, identification information related to the obtained key value. Subsequently, the higher layer traffic flow generating unit 220 uses the obtained higher layer rule information to generate and output the traffic flow of the higher layer data received from the lower layer classifying unit 110 of the lower layer processing unit 100.

As such, the multi-layer processing apparatus which integrates and processes multi-layer data using the lower layer processing unit 100 or processes higher layer data using the higher layer processing unit 200 may include a plurality of lower layer processing units and higher layer processing units, thereby improving data processing performance for integrating and processing multi-layer data. Specifically, if the higher data processing capability of the higher layer processing unit 200 is not sufficient, the multi-layer data processing apparatus may be configured to include a plurality of parallel higher layer processing units, and if the multi-layer data processing capability of the lower layer processing unit 100 is not sufficient, the multi-layer data processing unit may be configured to include a plurality of lower layer processing units. As such, the data processing capability of the multi-layer data processing apparatus can be improved.

The higher layer classifying unit 210 transmits to the lower layer processing unit 100 the higher layer rule information obtained from the rule information table of the global table unit 300. In response to receiving the higher layer rule information, the lower layer processing unit 100 stores the received higher layer rule information in the rule information table of the local table unit 121 to update the rule information table. The update of the rule information table of the local table unit 121 may be performed using a rule information updating unit 127.

When receiving the higher layer rule information through the higher layer classifying unit 210 of the higher layer processing unit 200, the rule information updating unit 127 updates the rule information table to correspond to the lower layer rule information of the rule information table of the local table unit 121 which is formed according to pre-set conditions. In addition, the rule information updating unit 127 checks the change of a state of the traffic flow of the multi-layer data which is generated by the multi-layer traffic flow generating unit 125 according to pre-set conditions, or checks the lower layer information to update the rule information table of the local table unit 121.

However, the updating of the rule information table may be performed in various ways. For example, a global rule information table formed in the global table unit 300 may be updated by the higher layer processing unit 200. That is, the lower layer processing unit 100 obtains particular rule information among the pieces of rule information received from the higher layer processing unit 200, and transmits to the higher layer processing unit 220 a traffic flow related to the obtained particular rule information. In response to receiving the traffic flow, the higher layer processing unit 200 checks the state of the traffic flow transmitted from the lower layer processing unit 100 using the pre-set conditions, and updates the rule information table of the global table unit 300. As described above, the multi-layer data processing apparatus shown in the example illustrated in FIG. 2 updates the rule information tables of the local table unit 121 and the global table unit 300, thereby enabling the lower layer processing unit 100 to process the data which is to be processed by the higher layer processing unit 200 in an integrated fashion.

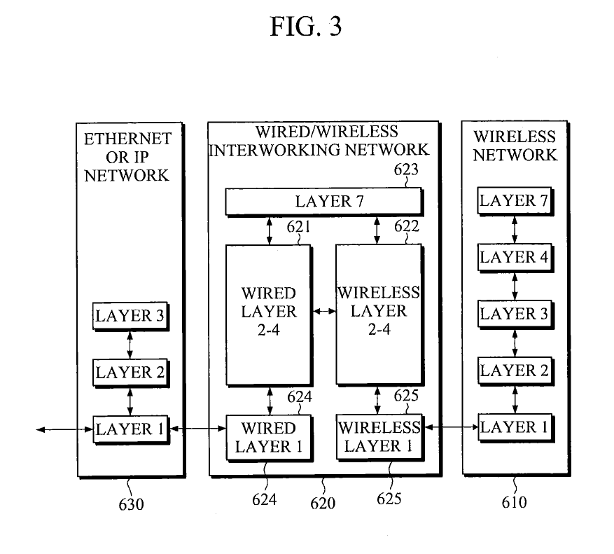

The multi-layer data processing apparatus may be applicable to a heterogeneous network interworking method by which data processing is performed in networks having different transfer schemes. Hereinafter, an example of processing multi-layer data in a heterogeneous network interworking scheme based on the technical concept of the data processing apparatus shown in the examples illustrated in FIGS. 1 and 2 will be provided in detail with reference to FIG. 3.

FIG. 3 illustrates an example of how to process multi-layer data using a data processing apparatus in a heterogeneous network interworking scheme.

Referring to FIG. 3, a packet of a frame is generated at an application layer (Layer 7) of a wireless network 610, the wireless network 610 transmits the packet or the frame through a layer 1 to a wireless layer 1 625 of a wired/wireless interworking network 620. In this case, connection between the wireless network 610 and the wired/wireless interworking network 620 is established using an interface and transfer scheme of the wireless network 610.

When receiving the packet or the frame through the layer 1 of the wireless network 610, the wireless layer 1 625 transmits the received packet or frame to a wireless layer 2-4 622. Then, the wireless layer 2-4 622 classifies the packet, obtains a packet or frame related to the wireless layer 2-4 622, and acquires rule and action information based on wireless layer 2-4 from the obtained packet or frame. Then, the wireless layer 2-4 622 generates a traffic flow of the obtained packet or frame using the acquired rule and action information based on wireless layer 2-4.

Additionally, the wireless layer 2-4 622 checks whether wired/wireless interworking rule and action information exists based on the classified packet or frame. If it is determined that wired/wireless interworking rule and action information is present, the wireless layer 2-4 622 a wired packet or a wired frame using the wired/wireless interworking rule and action information, and transmits the generated wired packet or wired frame to a wired layer 2-4 621. Thus, the wireless layer 2-4 622 is enabled to directly transmit the wired packet or wired frame to the wired layer 2-4 621.

If it is determined that wired/wireless interworking rule and action information is not present, the wireless layer 2-4 622 transmits the classified packet or frame to a layer 7 623. Then, the layer 7 623 obtains wired/wireless interworking rule and action information from the packet or frame received from the wireless layer 2-4 622. The layer 7 623 transmits the obtained wired/wireless interworking rule and action information to the wired layer 2-4 621.

As such, the wired layer 2-4 621 that receives the wired packet or wired frame from the wireless layer 2-4 621 or the layer 7 623 transmits the received wired packet or wired frame to a wired layer 1 624. The wired layer 1 624 that is connected with a layer 1 of Ethernet or an Internet protocol (IP) network transmits the received wired packet or wired frame to the layer 1. Accordingly, the Ethernet or IP network receives the wired packet or wired frame and generates a traffic flow in response.

As such, in the heterogeneous network interworking scheme, the performance of processing multi-layer data can be improved using the technical concept of the data processing apparatus.

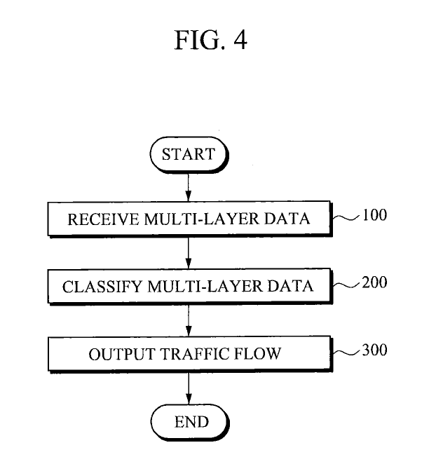

Hereinafter, a method of processing multi-layer data by integrating the multi-layer data using a multi-layer data processing apparatus will be described in detail with reference to FIGS. 4 to 6.

FIG. 4 illustrates a flowchart of an example of a method of processing multi-layer data.

Referring to FIG. 4, a multi-layer data processing apparatus receives multi-layer data from an external network (100). Here, the multi-layer data includes lower layer data and higher layer data. The multi-layer data processing apparatus which has received the multi-layer data classifies the multi-layer data into the higher layer data and the lower layer data (200). Then, a lower layer data processing unit obtains rule information related to the multi-layer data, which has been classified according to layers, with reference to a rule information table of a local table unit, and generates and outputs a traffic flow of the multi-layer data using the obtained rule information (300). The rule information table of the local table unit includes lower layer rule information related to processing of the lower layer data and higher layer rule information related to processing of the higher layer data which has been processed at a higher layer.

In another example, the lower layer rule information may be a rule set and action table based on Layer 2-4, and the higher layer rule information may be a rule set and action table based on Layer 7. In addition, the local table unit may store the rule information table which is formed such that rows of the rule set and action table based on the Layer 2-4 are linked to rows of the rule set and action table based on the Layer 7 in a ‘one-to-one’ or ‘one-to-n (n is a natural number greater than or equal to 2)’ relationship.

As described above, the lower layer processing unit classifies the received multi-layer data into the lower layer data and the higher layer data, and obtains the lower layer rule information related to the lower layer data from the rule information table of the local table unit. Then, the lower layer processing unit generates and outputs the traffic flows of the lower layer data and the higher layer data using the obtained lower layer rule information and higher layer rule information. Accordingly, the multi-layer data can be processed in an integrated manner.

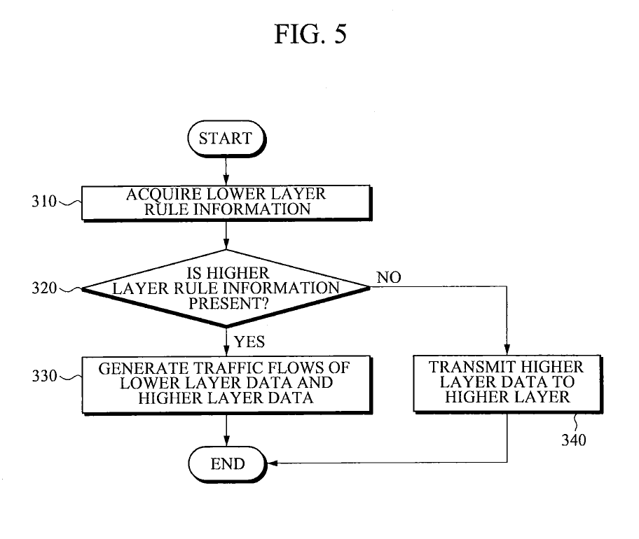

A method of generating a traffic flow of multi-layer data using a multi-layer data processing apparatus will be described with reference to FIG. 5.

FIG. 5 illustrates a flowchart of an example of a method of generating a traffic flow of multi-layer data. Referring to FIG. 5, when input multi-layer data is classified into lower layer data and higher layer data, a lower layer processing unit obtains lower layer rule information related to processing of the lower layer data from a local table unit (310). The lower layer data may contain a key value, and a rule information table of the local table unit may include identification information related to the key value. The lower layer processing unit acquires lower layer rule information from the rule information table including the identification information related to the key value of the lower layer data, among a plurality of tables stored in the local table unit.

Once obtaining the lower layer rule information, the lower layer processing unit checks whether there is higher layer rule information that corresponds to the obtained lower layer rule information (320). As described above, the local table unit may store the rule information table which is formed such that rows of the rule set and action table based on the Layer 2-4 are linked to rows of the rule set and action table based on the Layer 7 in a ‘one-to-one’ or ‘one-to-n (n is a natural number greater than or equal to 2)’ relationship. Thus, the lower layer processing unit is enabled to check the existence of the higher layer rule information that corresponds to the obtained lower layer rule information.

If it is determined that the higher layer rule information is present, the lower layer processing unit generates traffic flows of the lower layer data and the higher layer data using the obtained lower layer rule information and the corresponding higher layer rule information. Hence, the multi-layer data processing apparatus is able to generate and output a traffic flow of the input multi-layer data using the lower layer processing unit, thereby processing the multi-layer data in an integrated manner.

Alternatively, if it is determined that the higher layer rule information is not present, the lower layer processing unit takes necessary action for a higher layer processing unit to output a traffic flow of the higher layer data. Specifically, if it is determined that the higher layer rule information that corresponds to the obtained lower layer rule information does not exist, the lower layer processing unit transmits the higher layer data to the higher layer processing unit (340).

In response to receiving the higher layer data, the higher layer processing unit generates and outputs the traffic flow of the higher layer data, and transmits rule information used for generating the traffic flow to the lower layer processing unit. Specifically, when receiving the higher layer data from the lower layer processing unit, the higher layer processing unit obtains rule information related to processing of the higher layer data from the global rule information table of a global table unit. Here, the global rule information table of the global table unit includes pieces of rule information of all layers. The rule information of all layers may be rule set and action tables based on all layers. In addition, entire rule information table may include identification information related to a key value of data of each layer.

The higher layer processing unit obtains the higher layer rule information from a row of the rule information table including the identification information related to a key value of the received higher layer data, among the global rule information table. Then, the higher layer processing unit generates and outputs the traffic flow of the higher layer data using the obtained higher layer rule information. In addition, the higher layer processing unit transmits the higher layer rule information used for generating the traffic flow of the higher layer data to the lower layer processing unit.

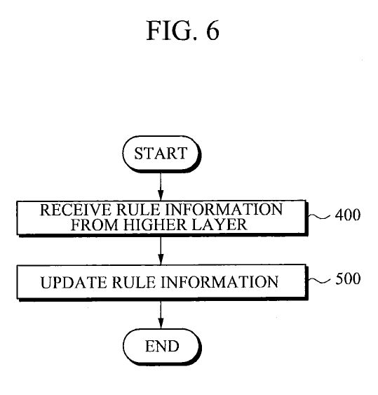

Consequently, the lower layer processing unit is able to update the rule information table of the local table unit using the received higher layer rule information. A method of updating rule information of the rule information table of the local table unit will be described with reference to FIG. 6.

FIG. 6 illustrates a flowchart of an example of a method of updating a rule information table of a local table.

Referring to FIG. 6, a lower layer processing unit receives higher layer rule information used for generating a traffic flow of higher layer data from a higher layer processing unit (400). Then, the lower layer processing unit stores the received higher layer rule information in a rule information table of a local table unit to update rule information of the rule information table. Specifically, when receiving the higher layer rule information from the higher layer processing unit, the lower layer processing unit links the received higher layer rule information to lower layer rule information determined according to pre-set conditions, and as a resultant updates the rule information table through the local table unit. In addition, the lower layer processing unit checks the lower layer information or the change of states of the traffic flow of the lower layer data and the traffic flow of the higher layer data based on the pre-set conditions, and updates the rule information table of the local table unit according to the check result.

As described above, the lower layer processing unit updates the rule information of the rule information table of the local table unit based on the rule information received from the higher layer processing unit or by checking the lower layer information and a change of a state of the generated traffic flow of the multi-layer data, thereby enabling the lower layer processing unit to process data which is to be processed by the higher layer processing unit in an integrated manner.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-layer data processing apparatus comprising:
a lower layer processing unit to classify received multi-layer data into lower layer data and higher layer data using lower layer information, generate a traffic flow of the lower layer data or traffic flows of the lower layer data and the higher layer data with reference to a rule information table in which pieces of lower layer rule information are linked to pieces of higher layer rule information and output the generated traffic flow(s).

2. The multi-layer data processing apparatus of claim 1, wherein the lower layer processing unit includes
a lower layer classifying unit to classify the received multi-layer data into the lower layer data and the higher layer data using the pieces of lower layer information, and
a local table processing unit to generate a traffic flow of each layer with reference to the rule information table in which the pieces of lower layer rule information related to processing of the lower layer data are linked to the pieces of higher layer rule information of the higher layer data that has been previously processed at a higher layer.

3. The multi-layer data processing apparatus of claim 2, further comprising:
a global table unit to store a global rule information table storing global rule information of all layers; and
a higher layer processing unit to receive the higher layer data from the lower layer processing unit, generate a traffic flow of the higher layer data using rule information of the global rule information table of the global table unit and output the generated traffic flow when the traffic flow of the higher layer data was not able to be generated by the lower layer processing unit.

4. The multi-layer data processing apparatus of claim 3, wherein the local table processing unit includes a local table unit to include the rule information table in which the pieces of lower layer rule information related to processing of the lower layer data are linked to the pieces of higher layer rule information of the higher layer data which has been previously processed by the higher layer processing unit in a ‘one-to-one’ or ‘one-to-n’ relationship where n is a natural number greater than or equal to 2.

5. The multi-layer data processing apparatus of claim 4, wherein the local table processing unit includes
a rule information acquiring unit to acquire the lower layer rule information related to processing of the lower layer data from the rule information table of the local table unit when the lower layer classifying unit has classified the multi-layer data into the lower layer data and the higher layer data, and
a multi-layer traffic flow generating unit to generate the traffic flow of the lower layer data.

6. The multi-layer data processing apparatus of claim 5, wherein the rule information acquiring unit checks whether higher layer rule information that corresponds, to the acquired lower layer rule information is present in the rule information table of the local table unit, and requests the multi-layer traffic flow generating unit to generate the traffic flow of the higher layer data if the corresponding higher layer rule information is present, or otherwise, requests the lower layer classifying unit to transmit the higher layer data to the higher layer processing unit.

7. The multi-layer data processing apparatus of claim 5, wherein the higher layer processing unit includes
a higher layer classifying unit to analyze the higher layer data received from the lower layer classifying unit, obtain rule information related to the received higher layer data from the global information table of the global table unit according to the analysis result, and transmit the obtained rule information to the lower layer processing unit, and
a higher layer traffic flow generating unit to generate the traffic flow of the higher layer data using the rule information obtained by the higher layer classifying unit.

8. The multi-layer data processing unit of claim 7, wherein the local table processing unit includes a rule information updating unit to update the rule information table of the local table unit using at least one of the rule information obtained from the higher layer classifying unit, state information of the traffic flow generated by the multi-layer traffic flow generating unit, and the lower layer information.

9. A multi-layer data processing method comprising:
receiving multi-layer data;
classifying the received multi-layer data into lower layer data and higher layer data; and
generating and outputting a traffic flow of the lower layer data or traffic flows of the lower layer data and the higher layer data with reference to a local rule information table in which pieces of lower layer rule information of the lower layer data are linked to pieces of higher layer rule information of the higher layer data which has been previously processed at a higher layer.

10. The multi-layer data processing method of claim 9, wherein the local rule information table stores a table in which the pieces of lower layer rule information are linked to the pieces of higher layer rule information in a ‘one-to-one’ or ‘one-to-n’ relationship where n is a natural number greater than or equal to 2.

11. The multi-layer data processing method of claim 9, wherein the generating and outputting of the traffic flow(s) includes
acquiring lower layer rule information related to processing of the lower layer data from the local rule information table,
checking whether higher layer rule information that corresponds to the acquired lower layer rule information is present in the local rule information table, and
acquiring the higher layer rule information when the corresponding higher layer rule information is present, and generating the traffic flows of the lower layer data and the higher layer data using the lower layer rule information and the higher layer rule information.

12. The multi-layer data processing method of claim 11, wherein the generating and outputting of the traffic flow(s) includes transmitting the higher layer data to the higher layer such that the traffic flow of the higher layer can be generated at the higher layer when the corresponding higher layer rule information is not present in the local rule information table.

13. The multi-layer data processing method of claim 12, further comprising:
receiving rule information related to generating of the traffic flow of the higher layer data when the traffic flow of the higher layer data has been generated at the higher layer; and
updating the local rule information table using at least one of the rule information obtained from the higher layer, state information of a traffic flow of the multi-layer data, and lower layer information.
